(19) United States
(12) Patent Application Publication
(10) Pub. No.: US 2006/0011249 A1
(43) Pub. Date: Jan. 19, 2006

(54) High pressure resistant vibration absorbing hose and method of producing the same

(76) Inventors: Tetsuya Arima, Kasugai-shi (JP); Norihiko Furuta, Komaki-shi (JP); Ayumu Ikemoto, Komaki-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/180,199

(22) Filed: Jul. 13, 2005

(30) Foreign Application Priority Data
Jul. 15, 2004 (JP) 2004-209182

(51) Int. Cl. F16L 11/00; F16L 33/00

(52) U.S. Cl. 138/109; 285/256

(57) ABSTRACT

A high pressure resistant vibration absorbing hose with a bursting pressure of 5 MPa or higher has a hose body and a joint fitting. The joint fitting is to be attached to a swaged portion of the hose body. The hose body has an inner surface rubber layer, a reinforcing layer of high braid or winding density of 50% or more, and an outer surface rubber layer. The swaged portion is designed to have a larger diameter than the main portion of the hose body and the inner surface rubber layer has a wall thickness equal to or larger than 1.0 mm at a swaged portion in a state before the joint fitting is securely swaged thereto. The reinforcing layer has a braid or winding angle θ of a reinforcing wire member equal to or lower than a neutral angle 54.7° and higher than 48°.

### BACKGROUND OF THE INVENTION

The present invention relates to a high pressure resistant vibration absorbing hose, specifically a high pressure resistant vibration absorbing hose to be applied preferably for plumbing in an engine room of a motor vehicle, and a method for producing the same.

Since the past, a hose mainly composed of a tubular rubber layer has been widely used in a variety of industrial and automotive applications. Main purpose of applying such rubber hose is for absorption of vibration. For example, in case of plumbing hose to be arranged in an engine room of a motor vehicle, the plumbing hose serves as to absorb engine vibration, compressor vibration of an air conditioner (in case of a hose for conveying refrigerant, namely an air conditioning hose) and other various vibration generated during car driving, and to restrain transmission of the vibration from one member to the other member which is joined with the one member via the plumbing hose.

Meanwhile, regardless of industrial or automotive applications, hoses for oil system, fuel system, water system and refrigerant system have multi-layered construction including inner surface rubber layer (inner surface layer), outer surface rubber layer (outer surface layer) and reinforcing layer interposed between the inner and outer surface rubber layers, for example, as disclosed in the Patent Document No. 1 below. The reinforcing layer is constructed by braiding or spirally winding reinforcing yarns (reinforcing wire member).

FIG. 8 (A) shows construction of a refrigerant conveying hose (air conditioner hose) which is disclosed in the Patent Document 1 below. Reference numeral 200 in FIG. 8 (A) indicates a tubular inner surface rubber layer. Resin inner layer 202 is formed in and laminated over an inner surface of the inner surface rubber layer 200.

And, first reinforcing layer 204 is formed or laminated on an outer side of the inner surface rubber layer 200, and second reinforcing layer 206 is formed or laminated on an outer side of the first reinforcing layer 204 with intervening intermediate rubber layer 208 between the first and the second reinforcing layers 204, 206. The first reinforcing layer 204 is formed by spirally winding reinforcing yarn or yarns while the second reinforcing layer 206 is formed by spirally winding reinforcing yarn or yarns in the reverse direction to the winding direction of the first reinforcing layer 204. Further, outer surface rubber layer 210 of outermost layer, which serves as cover layer, is formed or laminated on outer side of the second reinforcing layer 206.

In this example, the reinforcing layers 204, 206 are formed by spirally arranging or winding reinforcing yarns. On the other hand, such reinforcing layer is also formed by braiding reinforcing yarns.

FIG. 8 (B) shows an example of a hose having such braided reinforcing layer. Reference numeral 212 in FIG. 8 (B) indicates reinforcing layer which is formed by braiding reinforcing yarns between the inner surface rubber layer 200 and the outer surface rubber layer 210.

Even in this example, the resin inner layer 202 is also formed in and laminated over an inner surface of the inner surface rubber layer 200.

Meanwhile, in case of such straight-sided or straight-walled tubular hose, in the past the hose has been required to have a predetermined length in order to ensure favorable vibration absorbing property.

In particular, compared to low-pressure hoses for fuel system, water system or the like, a longer length is required for high pressure resistant hoses for oil system (for example, power steering system), refrigerant system (refrigerant conveying system) or the like to absorb vibration and reduce transmission of noise and vibration to vehicle interior, commensurate with rigidity of the hoses.

For example, in case of refrigerant conveying hose, typically the hose of 300 mm to 600 mm in length is adapted to absorb vibration and reduce transmission of noise and vibration, even for plumbing or piping for direct distance of 200 mm.

However, an engine room is crammed with variety of components and parts. And, specifically in these days, an engine room has been designed in more and more compact size. Therefore, under the circumstances, if a long hose is arranged in the engine room, it bothers an design engineer to design plumbing arrangement to avoid interference with other components or parts and an operator to handle the hose when arranging the hose in the engine room. Further, such plumbing design and handling of the hose according to a type of motor vehicles should be devised. These result in excessive work load.

In view of foregoing aspects, it is demanded to develop a hose that has a short length and can absorb vibration favorably.

As for one of the means to design the hose in short length while securing vibration absorbing property, it is assumed to form the hose with corrugations.

When the hose is formed with corrugations, flexibility of the hose is drastically improved. However, once high pressure is exerted internally to the hose by fluid, the hose is entirely elongated largely in an axial direction.

In this instance, when the hose is in a fixed state at opposite ends thereof (usually a hose is applied in this manner), the hose is entirely curved largely and there caused a problem of interference with other components and parts around the hose.

As a conclusion, it is not a sufficient countermeasure to provide the hose with corrugation.

Meanwhile, in case of a high pressure resistant hose such as an air conditioning hose, when a high pressure is exerted to the hose by a fluid directed in the inside thereof, the hose and the fluid work together, the hose thereby exhibits the rigid-body like behavior much more than when such high pressure is not exerted to the hose.

The larger the cross-sectional area of the hose including the fluid is, the greater the degree of the rigidity is.

That is, the smaller the cross-sectional area of the hose including the fluid is, the less the degree of the rigidity is, resulting that the vibration absorbing property is increased by just that much.

Therefore, in order to design a hose non-corrugated and short in length while enhancing vibration absorbing property of the hose, it is effective means to form the hose with small diameter.

However, if a hose is formed just with a small diameter entirely including axial end portions of the hose, and in addition, a joint fitting is formed also with a small diameter, an insert pipe to be adapted inside the joint fitting must be formed also with a small inner diameter. Therefore, resultantly, pressure loss is caused on the portion of the joint fitting during transporting fluid or a required flow amount cannot be secured in such hose.

On the other hand, if a hose or hose body is formed with a small diameter at a swaged portion on a hose or hose body end portion and a large diameter joint fitting having an insert pipe with large inner diameter is applied, insertion resistance is extremely increased when the insert pipe is inserted in the swaged portion on the axial end portion, and insertability of the insert pipe is impaired. Therefore, it is virtually difficult to attach the joint fitting to the swaged portion.

So, if a hose is intended to be formed with a small diameter, it is preferred that only a main portion is formed with a small diameter without forming the swaged portion on the axial end portion with a small diameter.

In this case, the swaged portion on the axial end portion has relatively larger diameter than the main portion has.

As for measure to produce such hose having a large diameter on the axial end portion, it is assumed to form first an unvulcanized hose body in a straight-walled cylindrical shape, then diametrically enlarge or deform only axial end portions thereof, and vulcanize the unvulcanized hose body.

For example, the following Patent Documents No. 2 and No. 3 disclose water system hoses such as radiator hose. Each of the patent documents discloses that an unvulcanized hose body is formed by extrusion, a mandrel is inserted in an axial end portion of the unvulcanized hose body, then the unvulcanized hose body is vulcanized and formed with the mandrel therein to diametrically enlarge the axial end portion of the hose body.

In such water system hose as disclosed in the Patent Documents 2 and 3, a bursting pressure is small and braid or winding density of a reinforcing layer is low, about 15 to 25%. In this case, the difficulty lies not so much in diametrically enlarging the axial end portion of the hose body. However, in a high density and high-pressure resistant hose that has a bursting pressure equal to or larger than 5 MPa and includes a reinforcing layer with a braid or winding density equal to or larger than 50%, resistance by the reinforcing layer is remarkably increased when the mandrel is inserted in the axial end portion, and diametrically enlarging work is made abruptly difficult.

In case that a hose body is formed first in a straight-walled cylindrical shape and an axial end portion thereof is diametrically enlarged in a later step, there will necessarily be a problem that a wall thickness of the large diameter portion, namely the swaged portion on the axial end portion becomes thin.

For the swaged or compressed portion of the axial end portion of the hose, swaging or compressing rate is usually required to be set about 25 to 50%, considering varied wall-thickness of portions to be swaged or compressed, or fastening strength for a portion to be swaged or compressed. If the wall-thickness of the portion to be swaged becomes thin by diametrically enlarging the axial end portion, there occurs a problem that the swaged portion, specifically a swaged portion of the inner surface layer happens to be broken by swaging or compressing operation.

Incidentally, each of the hoses disclosed in the Patent Documents No. 2 and No. 3 is not a type in which a joint fitting is swaged, and therefore, no problem is caused.

In order to solve this problem, it can be assumed to form separately an inner surface layer by injection molding. However, in a method of producing the inner surface layer by injection molding, productivity is low, necessarily resulting high production cost.

[Patent Document 1] JP, A, 7-68659

[Patent Document 2] JP, B, 3244183

[Patent Document 3] JP, B, 8-26955

Under the circumstances described above, it is an object of the present invention to provide a novel high pressure resistant vibration absorbing hose which can be produced not by a method of injection molding described above and a novel method for producing the same. In the novel high pressure resistant vibration absorbing hose, it is possible diametrically enlarge a swaged portion on an axial end portion of a hose body, and breakage is hardly caused in the diametrically enlarged portion when a joint fitting is securely swaged thereto.

### SUMMARY OF THE INVENTION

According to one aspect of the present invention, there is provided a novel high pressure resistant vibration absorbing hose that comprises a hose body and a joint fitting. The hose body has an inner surface layer, a reinforcing layer that is formed on an outer side of the inner surface layer by braiding or spirally winding reinforcing wire member and an outer surface layer as cover layer on an outer side of the reinforcing layer. The reinforcing layer has a high braid or winding density of the reinforcing wire member of 50% or more. The hose body has a swaged portion on an axial end portion thereof and a main portion other than the swaged portion. Each of the inner surface layer, the reinforcing layer and the outer surface layer also has a swaged portion and a main portion corresponding to the swaged portion and the main portion of the hose body. The joint fitting is attached to the swaged portion of the hose body, and has a rigid insert pipe and a sleeve-like socket fitting. The joint fitting is securely fixed to the swaged portion by securely swaging the socket fitting to the swaged portion in a diametrically contracting direction while the insert pipe is inserted within the swaged portion and the socket fitting is fitted on an outer surface of the swaged portion. A bursting pressure of the high pressure resistant vibration absorbing hose is 5 MPa or more. The swaged portion of the hose body is designed to have a larger diameter than the main portion of the hose body in a state (shape) before the joint fitting is securely swaged thereto. The inner surface layer has a wall thickness equal to or larger than 1.0 mm at the swaged portion in a state before the joint fitting is securely swaged thereto. The reinforcing layer has a braid or winding angle θ of the reinforcing wire member equal to or lower than a neutral angle 54.7° and higher than 48°, i.e., in a range over 48° to the neutral angle 54.7°, for example, at the main portion. The braid or winding angle θ is an angle of orientation of the reinforcing wire member with respect to an axis.

Here, the braid or winding density means a ratio of an area of the reinforcing wire member to an area of the reinforcing layer. When the reinforcing wire member is arranged without clearance or with zero clearance, the braid density or winding density is 100%.

The inner surface layer may have a wall thickness equal to or larger than 1.5 mm at the swaged portion in the state (shape) before the joint fitting is securely swaged thereto. The reinforcing layer may have a braid or winding angle θ of the reinforcing wire member in a range from 50° to 53°.

According to one aspect of the present invention, there is provided a novel method for producing a high pressure resistant vibration absorbing hose, for example, as defined in claim 1 or claim 2. The method for producing the high pressure resistant vibration absorbing hose comprises (a) a step of forming an unvulcanized hose body of a straight-walled cylindrical shape laminated with an inner surface rubber layer as the inner surface layer, the reinforcing layer and an outer surface rubber layer as the outer surface layer, (b) a step of diametrically enlarging an axial end portion of the unvulcanized hose body by force fitting a mandrel or mandrel mold inside the axial end portion thereof, after the step of (a), and (c) a step of vulcanizing the unvulcanized hose body while maintaining the axial end portion thereof in diametrically enlarged state. An outer surface of the main portion of the unvulcanized hose body is retained and restrained by a retaining member or retaining mold when the mandrel is force fitted inside the axial end portion thereof. The retaining member may have a cylindrical inner surface, for example, with an inner diameter equal to or generally equal to an outer diameter of the unvulcanized hose body of a straight-walled cylindrical shape or the main portion of the unvulcanized hose body. The mandrel is force fitted in the axial end portion of the unvulcanized hose body in which the outer surface of the main portion is retained and restrained by the retaining member, so as to diametrically enlarge the axial end portion. In the step of forming an unvulcanized hose body, namely in the step (a), the reinforcing layer may be designed to have the braid or winding angle θ of the reinforcing wire member equal to or lower than a neutral angle 54.7° and higher than 48°. And, in the step of vulcanizing the unvulcanized hose body, namely in the step (c), or after the step of diametrically enlarging the axial end portion, namely after the step (b), the inner surface layer may have the wall thickness equal to or larger than 1.0 mm at the swaged portion.

In the method for producing the high pressure resistant vibration absorbing hose according to one aspect of the present invention, the mandrel may be force fitted inside the axial end portion of the unvulcanized hose body while an internal pressure is exerted in the unvulcanized hose body. Here, the internal pressure may be exerted in the unvulcanized hose body by way of a pressurizing fluid path running axially through the mandrel.

As stated above, according to one aspect of the present invention, a high pressure resistant vibration absorbing hose, in which a joint fitting is securely swaged to a swaged portion or to-be-swaged portion on an axial end portion of the hose body, has a bursting pressure equal to or larger than 5 MPa. In the high pressure resistant vibration absorbing hose, the reinforcing layer is formed by braiding or winding spirally a reinforcing wire member at high braid or winding density equal to or larger than 50%, the swaged portion of the hose body is designed to have a larger diameter than the main portion of the hose body in a state (shape) before the joint fitting is securely swaged thereto, the inner surface layer has a wall thickness equal to or larger than 1.0 mm at the swaged portion in a state before the joint fitting is securely swaged thereto, and further, the reinforcing layer has a braid or winding angle θ of the reinforcing wire member equal to or lower than a neutral angle 54.7° and higher than 48°.

The high pressure resistant vibration absorbing hose according to one aspect of the present invention has a bursting pressure equal to or larger than 5 MPa, and includes the reinforcing layer which has a high braid or winding density of the reinforcing wire member equal to or larger than 50%. In spite of that, as the reinforcing layer has a braid or winding angle θ of the reinforcing wire member equal to or lower than a neutral angle 54.7°, it is possible to diametrically enlarge an axial end portion of a hose body which is first formed in a straight-walled cylindrical shape without difficulty during diametrically enlarging work.

If the reinforcing layer has a braid or winding angle of the reinforcing wire member larger than the neutral angle, it virtually becomes difficult to diametrically enlarge the axial end portion of the hose or hose body. However, as the hose according to one aspect of the present invention includes the reinforcing layer has a braid or winding angle θ of the reinforcing wire member equal to or lower than the neutral angle, it is possible to diametrically enlarge the axial end portion of the hose body without trouble.

In the reinforcing layer, the smaller the braid or winding angle of the reinforcing wire member is, the smaller the resistance by the reinforcing layer becomes. And, it becomes easy to diametrically enlarge the axial end portion of the hose body.

However, on the other hand, when a high pressure is exerted internally by a fluid, the smaller the braid or winding angle is in the reinforcing layer, the larger a radial expanding amount becomes at the main portion of the hose body. As a result, durability to repeated pressures or impulse is lowered.

So, according to one aspect of the present invention, the reinforcing layer has the braid or winding angle θ larger than 48°, therefore, there causes no such trouble and the radial expansion of the main portion by action of high pressure fluid maybe effectively reduced and durable life under repeated pressures may be enhanced.

And, according to one aspect of the present invention, as the inner surface layer has the wall thickness equal to or larger than 1.0 mm at the swaged portion on the axial end portion thereof after diametrically enlarged, the joint fitting may be favorably and advantageously attached to the hose body without causing breakage in a diametrically enlarged portion, namely the swaged portion when the joint fitting is securely swaged to the swaged portion.

As stated above, the method for producing the high pressure resistant vibration absorbing hose according to one aspect of the present invention comprises a step of forming or producing an unvulcanized hose body of a straight-walled cylindrical shape laminated with an inner surface rubber layer as the inner surface layer, the reinforcing layer and an outer surface rubber layer as the outer surface layer, a following step of diametrically enlarging an axial end portion of the unvulcanized hose body by force fitting a mandrel inside the axial end portion thereof, and a yet following step of vulcanizing the unvulcanized hose body while maintaining the axial end portion thereof in diametrically enlarged state. An outer surface of the main portion of the unvulcanized hose body is retained and restrained by a retaining member when the mandrel is force fitted inside the axial end portion thereof. And, the mandrel is force fitted in the axial end portion of the unvulcanized hose body in which the outer surface of the main portion is retained and restrained by the retaining member, so as to diametrically enlarge the axial end portion thereof. According to this method, as the outer surface of the main portion is retained and restrained by the retaining member when the mandrel is force fitted to and inside the axial end portion to diametrically enlarge the axial end portion, it may be favorably prevented that buckling of the axial end portion is caused by fitting force of the mandrel in axial direction, and therefore the axial end portion may be favorably diametrically enlarged.

If the reinforcing layer has the high braid or winding density of the reinforcing wire member equal to or larger than 50% in order to provide high pressure resistance with the hose, a large resistance is exerted to the mandrel by the reinforcing layer when the mandrel is force fitted to and inside the axial end portion to diametrically enlarge the axial end portion. So, when the mandrel is force fitted, a problem of axial buckling of the axial end portion tends to occur. However, according to one aspect of the present invention, the mandrel may be smoothly force fitted inside the axial end portion thanks to retaining and restraining action by the restraining member without such problem and thereby the axial end portion may be favorably diametrically enlarged.

According to one aspect of the present invention, the mandrel is force fitted in the axial end portion while radially expanding force is exerted in the unvulcanized hose body by applying an internal pressure in the unvulcanized hose body. Thereby the axial end portion may be more easily diametrically enlarged by force fitting of the mandrel.

The wording “an inner surface layer” indicates a rubber layer provided in an inner side of a reinforcing layer or reinforcing layer construction, namely “an inner surface rubber layer”. “The inner surface rubber layer” constitutes, for example, an innermost layer. “The outer surface layer” constitutes, for example, an outermost layer.

Now, the preferred embodiments of the present invention will be described in detail with reference to the drawings.

### BRIEF DESCRIPTION OF THE DRAWINGS

FIG. 1 (A) is a view showing a hose according to one embodiment of the present invention.

FIG. 1 (B) is a view showing a construction of a part B of FIG. 1(A).

FIG. 2 is an enlarged sectional view showing a relevant part of the hose according to the one embodiment.

FIG. 3 (A) is a view showing a hose body of FIG. 1 (A) in unvulcanized state before diametrically enlarged.

FIG. 3 (B) is a view showing a reinforcing layer of the hose body of FIG. 3 (A).

FIG. 4 (A) is an explanatory view showing one step in a method for producing the high pressure resistant vibration absorbing hose, according to one embodiment of the present invention.

FIG. 4 (B) is an explanatory view showing a step following the step of FIG. 4 (A).

FIG. 4 (C) is an explanatory view showing a step following the step of FIG. 4 (B).

FIG. 4 (D) is an explanatory view showing a step following the step of FIG. 4 (C).

FIG. 5 (A) is a view showing the hose body of FIG. 1 (A) of which axial end portions are diametrically enlarged in a state before joint fittings are securely swaged thereto.

FIG. 5 (B) is an enlarged sectional view showing a part B of FIG. 5 (A).

FIG. 6 (A) is an explanatory view of a main step in another method different from the method in FIG. 4 for producing the high pressure resistant vibration absorbing hose, according to one embodiment of the present invention.

FIG. 6 (B) is an explanatory view showing a main step following the main step of FIG. 6(A).

FIG. 7 is an explanatory view showing a method for test conducted for example and comparison example hoses.

FIG. 8 (A) is a view showing one type of a conventional hose.

FIG. 8 (B) is a view showing another type of a conventional hose.

### DETAILED DESCRIPTIONS OF PREFERRED EMBODIMENTS

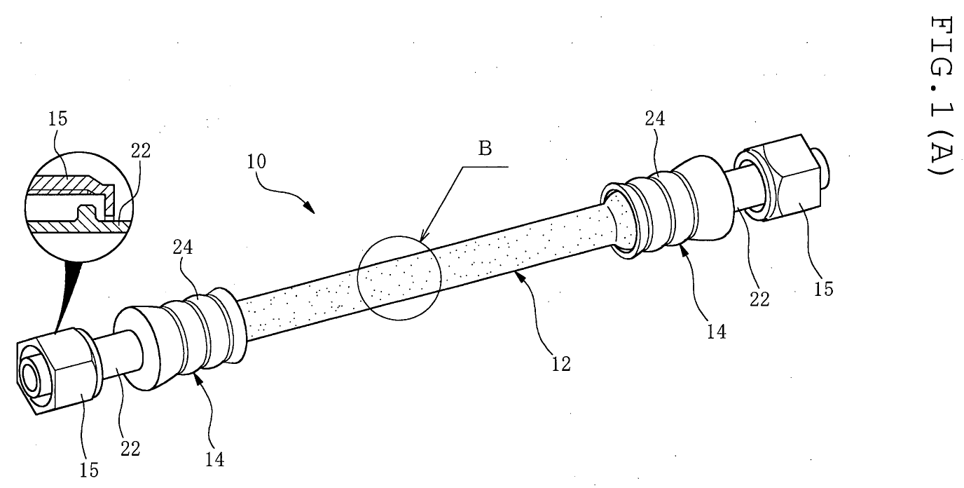

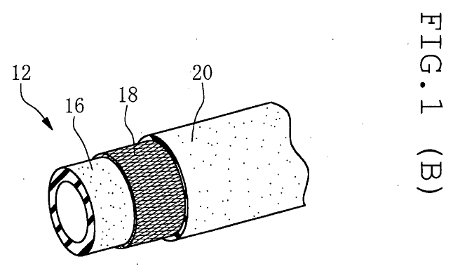

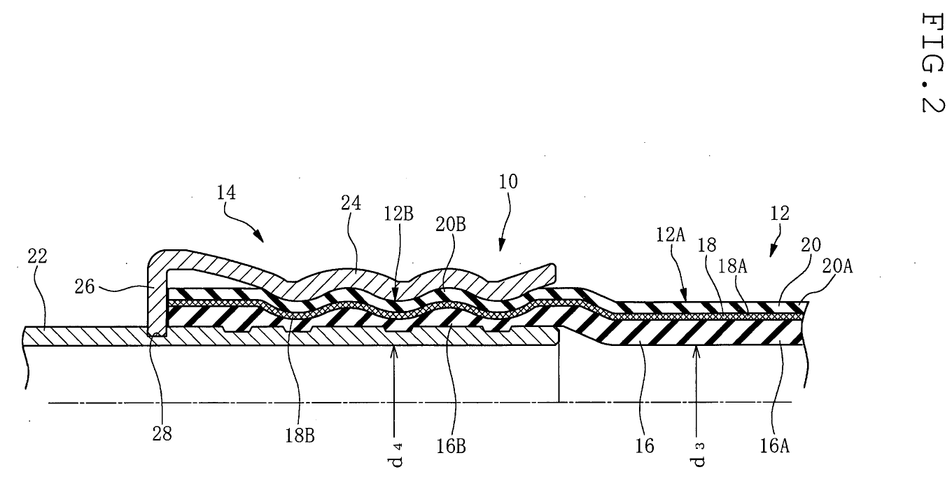

In FIGS. 1 (A) and (B), reference numeral 10 indicates a high pressure resistant vibration absorbing hose (hereinafter simply referred to as a hose), which is applied, for example, as refrigerant conveying hose (air conditioning hose) or the like, has a hose body 12 and a pair of joint fittings 14 which are securely swaged or compressed on swaged or compressed portions 12B on axial end portions thereof (refer to FIG. 2). As shown in FIG. 1 (B), the hose body 12 has multi-layered construction, an inner rubber layer or inner surface rubber layer (inner surface layer) 16 of an innermost layer, a reinforcing layer 18 which is formed by braiding reinforcing yarn or reinforcing filament member (reinforcing wire member) on an outer side of the inner surface rubber layer 16, and an outer rubber layer or outer surface rubber layer (outer surface layer) 20 of an outermost layer as cover layer. The reinforcing layer 18 may be also formed by spirally winding the reinforcing yarn or reinforcing filament member.

For the reinforcing yarns or filament members forming the pressure resistant reinforcing layer 18, polyethylene terephthalate (PET), polyethylene naphthalate (PEN), aramid, polyamide or nylon (PA), vynilon, rayon, metal wire or the like may be adapted.

The inner surface rubber layer 16 may be formed from isobutylene-isoprene rubber (IIR), halogenated IIR (chloro-IIR (Cl-IIR or CIIR), bromo-IIR (Br-IIR or BIIR)), acrylonitrile-butadiene-rubber (NBR), chloroprene rubber (CR), ethylene-propylene-diene-rubber (EPDM), ethylene-propylene copolymer (EPM), fluoro rubber (FKM), epichlorohydrin rubber or ethylene oxide copolymer (ECO), silicon rubber, urethane rubber, acrylic rubber or the like. These materials are applied in single or blended form for the inner surface rubber layer 16.

However, in case where the hose 10 is applied for hydrofluorocarbon (HFC) type refrigerant conveying hose, specifically IIR or halogenated IIR in single or blended form may be preferably used.

The outer surface rubber layer 20 may be formed also from every kind of rubber materials cited above as material for the inner surface rubber layer 16. In addition, heat-shrinkable tube and thermoplastic elastomer (TPE) are also applicable for the outer surface rubber layer 20. As for material of such heat-shrinkable tube and TPE, acrylic type, styrene type, olefin type, diolefin type, polyvinyl chloride type, urethane type, ester type, amide type, fluorine type or the like may be applied.

As shown in FIG. 2, the above joint fitting 14 has a rigid metal insert pipe 22 and a sleeve-like socket fitting 24. The insert pipe 22 is inserted in the swaged portion 12B of an axial end portion of the hose body 12, the socket fitting 24 is fitted on an outer surface of the swaged portion 12B. Then, the socket fitting 24 is swaged in a diametrically contracting direction, and securely swaged on the swaged portion 12B. The joint fitting 14 is thereby securely swaged on the hose body 12 while the swaged portion 12B is clamped in an inward and outward direction by the socket fitting 24 and the insert pipe 22.

Here, the socket fitting 24 includes an inwardly directed annular stop portion 26. An inner peripheral end portion of the stop portion 26 is fitted and stopped in an annular stop groove 28 in an outer peripheral surface of the insert pipe 22.

Reference numeral 15 in FIG. 1 (A) indicates a hexagon cap nut or a mounting nut which is rotatably mounted on the insert pipe 22.

As shown in FIG. 2, in this embodiment, an inner diameter of a main portion 12A of the hose body 12, specifically an inner diameter d₃ of the inner surface rubber layer 16 at the main portion 12A (a main portion 16A of the inner surface rubber layer 16) and an inner diameter d₄ of the insert pipe 22 are designed identical.

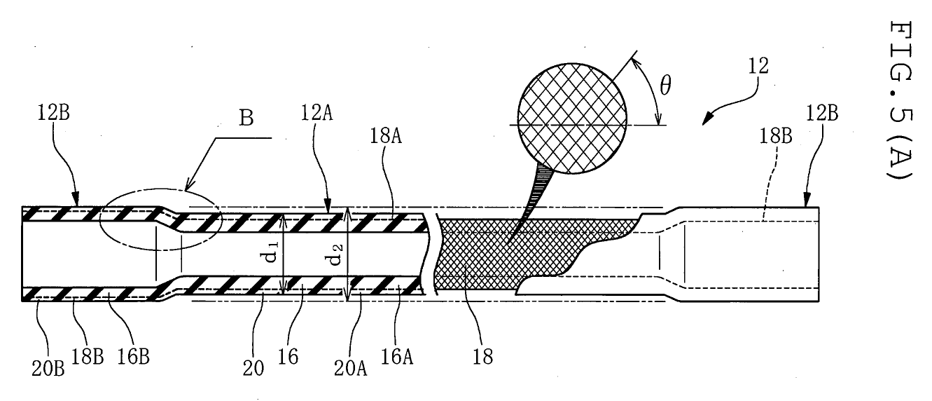

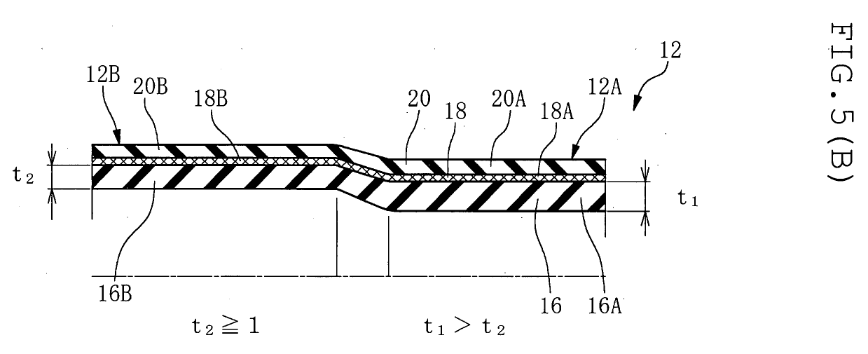

FIG. 5 (A) shows a shape of the hose body 12 before the joint fitting 14 is securely swaged thereto.

In FIG. 5 (A), reference numeral 12A indicates the main portion of the hose body 12, and reference numeral 12B indicates a swaged portion or to-be-swaged portion on an axial end portion thereof. As shown in FIG. 5 (A), in this embodiment, an outer diameter d₁ of the main portion 12A is smaller than an outer diameter d₂ of the swaged portion 12B. An inner diameter of the main portion 12A is smaller than an inner diameter of the swaged portion 12B.

That is, in a conventional hose of this type, an outer diameter of a main portion 12A of a hose body 12 is designed the same as an outer diameter of a swaged portion 12B thereof. However, in this embodiment, only the main portion 12A is formed with smaller diameter.

As a result, the swaged portion 12B is larger in diameter than the main portion 12A, or diametrically enlarged with respect to the main portion 12A.

In FIG. 5, reference numeral 16A indicates a main portion of the inner surface rubber layer 16 and reference numeral 16B indicates a swaged portion thereof (the inner surface rubber layer 16 at the swaged portion 12B). Reference numeral 18A indicates a main portion of the reinforcing layer 18 (the reinforcing layer 18 at the main portion 12A) and reference numeral 18B indicates a swaged portion or to be swaged portion thereof.

Further, numeral reference 20A indicates a main portion of the outer surface rubber layer 20, and 20B indicates a swaged portion or to be swaged portion thereof.

In the hose body 12, the reinforcing layer 18 is designed such that a braid angle θ of the reinforcing yarn or filament member is equal to or lower than a neutral angle 54.7° and greater than 48.0° at the main portion 18A.

As shown in FIG. 5 (B), in the inner surface rubber layer 16, a wall thickness t₂ of the swaged portion 16B is smaller than a wall thickness t₁ of the main portion 16A. However, the wall thickness t₂ is equal to or larger than 1.0 mm.

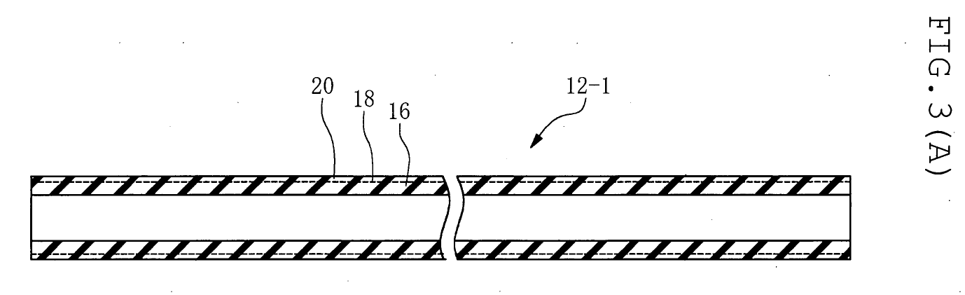

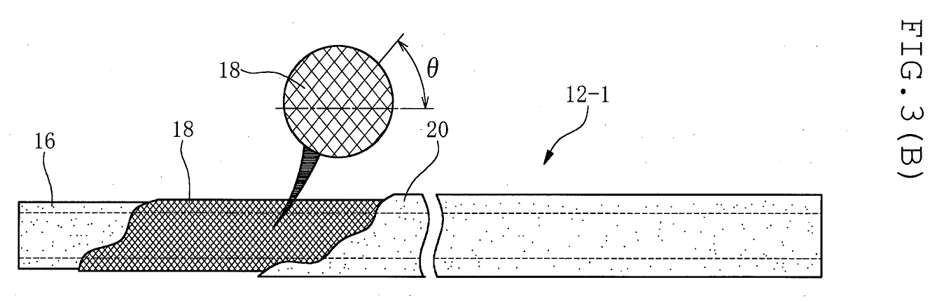

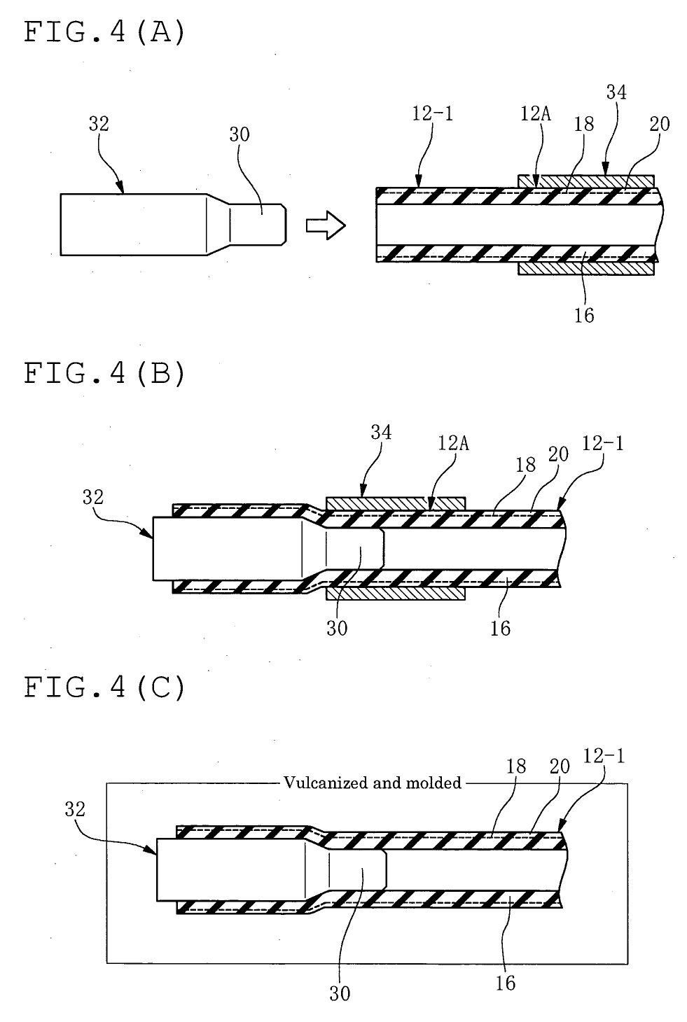

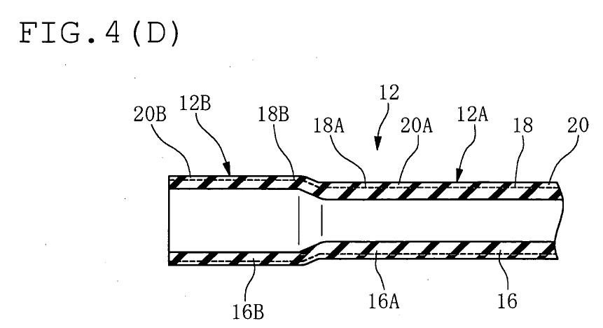

FIGS. 3 and 4 show a method for producing the hose 10 according to this embodiment. As shown in FIG. 3 (B), in the method of this embodiment for producing the hose 10, first, the inner surface rubber layer 16, the reinforcing layer 18 and the outer surface rubber layer 20 are laminated on one another (in this order) and thereby formed is an unvulcanized hose or hose body 12-1 of straight-walled cylindrical shape.

A braid angle θ of a reinforcing yarn or filament member in the reinforcing layer 18 here is the same as a braid angle θ of the reinforcing yarn or filament member in the main portion 18A shown in FIG. 5.

Then, as shown in FIG. 4 (A), the unvulcanized hose body 12-1 is diametrically enlarged or deformed at an axial end portion thereof by means of a mandrel 32 that has a large diameter portion and a small diameter portion 30 on a leading end of the large diameter portion thereof. In the mandrel 32, the large diameter portion has an outer diameter larger than an inner diameter of the unvulcanized hose body 12-1 of a straight-walled cylindrical shape, while the small diameter portion 30 has an outer diameter identical to or generally identical to the inner diameter of the unvulcanized hose body 12-1 of a straight-walled cylindrical shape.

At this time, a retaining mold or retaining member 34 of cylindrical shape is also used for diametrically enlarging the unvulcanized hose or hose body 12-1. Specifically, while the retaining member 34 of cylindrical shape is fitted on the main portion 12A of the unvulcanized hose body 12-1 to retain and restrain an outer surface thereof, the mandrel 32 is force fitted axially to and inside the axial end portion thereof. Thereby the axial end portion of the unvulcanized hose body 12-1 is diametrically enlarged in a shape corresponding to a shape and an outer diameter of the mandrel 32 (refer to FIG. 4 (B)). The mandrel 32 is force fitted in the unvulcanized hose body 12-1 until the large diameter portion of the mandrel 32 enters in the axial end portion of the hose body 12-1 and the small diameter portion 30 thereof enters in the retaining member 34.

During that time, the main portion 12A is retained and restrained by the restraining member 34. Therefore, even in case that the mandrel 32 is force fitted in the unvulcanized hose body 12-1 by overcoming resistance of the reinforcing layer 18 in a diametrically enlarging direction, the axial end portion is favorably diametrically enlarged by the mandrel 32 without causing buckling of the axial end portion.

And, according to this embodiment, as the braid angle θ of the reinforcing yarn or filament member is equal to or lower than the neutral angle in the reinforcing layer 18, the resistance by the reinforcing layer 18 is lowered when the mandrel 32 is inserted in the axial end portion. So, the mandrel 32 may be easily inserted in the axial end portion and the axial end portion of the unvulcanized hose body 12-1 may be easily diametrically enlarged.

After the axial end portion is diametrically enlarged, a wall thickness of the swaged portion 16B of the inner surface rubber layer 16 becomes small due to diametrical enlargement of the axial end portion. However, the wall thickness t₂ of the swaged portion 16B is secured 1.0 mm or larger after the diametrical enlargement.

In other words, a wall thickness of the inner surface rubber layer 16, specifically the wall thickness t₁ of the main portion 16A is determined such that the wall thickness t₂ of the swaged portion 16B thereof is equal to or larger than 1.0 mm after the axial end portion is diametrically enlarged at a predetermined diametrically enlarging rate by insertion of the mandrel 32.

After the axial end portion is diametrically enlarged by insertion of the mandrel 32 as described above, the unvulcanized hose body 12-1 is vulcanized with the mandrel 32 therein (FIG. 4 (C)).

And, after the vulcanizing process of FIG. 4 (C) is completed, the mandrel 32 is removed, and the joint fitting 14 is securely swaged on the swaged portion 12B of the hose body 12 which is diametrically enlarged.

Thereby the hose 10 as shown in FIG. 1 is obtained.

In the inner surface rubber layer 16 of this embodiment, the main portion 16A is designed to have the wall thickness t₁ required for providing the hose 10 with favorable vibration absorbing property, and on the other hand, required for providing the hose 10 with impermeability to internal fluid or water impermeability.

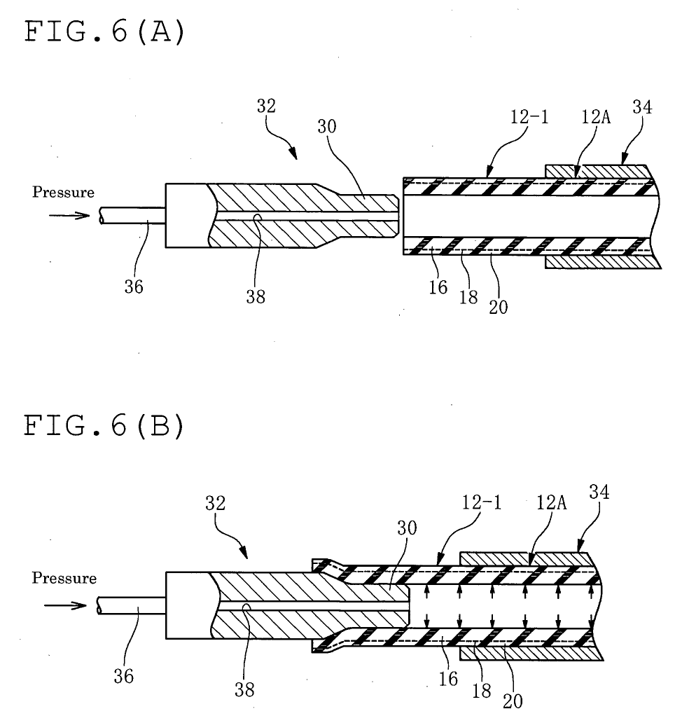

In FIG. 4, the mandrel 32 is just force fitted and inserted in the axial end portion of the unvulcanized hose body 12-1. However, if the mandrel 32 is hard to be force fitted therein due to the resistance of the reinforcing layer 18, the mandrel 32 may be provided with a tube or tube body 36, while a path or fluid path (pressurizing fluid path) 38 is formed so as to run axially through the mandrel 32 as shown in FIG. 6. Then, a pressurizing fluid may be introduced inside the unvulcanized hose body 12-1 through a tube body 36 and the fluid path 38. In this manner, while an internal pressure is exerted inside the unvulcanized hose body 12-1, the mandrel 32 may be force fitted and inserted in the unvulcanized hose body 12-1.

For example, it is relatively easy to force fit the mandrel 32 in the unvulcanized hose body 12-1 when the axial end portion is diametrically enlarged at a diametrically enlarging rate within 10%. However, the diametrically enlarging rate exceeding 10% sometimes makes it difficult to force fit the mandrel 32 in the unvulcanized hose body 12-1 without specific means. In this case, the mandrel 32 with the fluid path 38 may be applied. And, while the internal pressure is exerted inside the unvulcanized hose body 12-1 through the fluid path 38 from the tube body 36, the mandrel 32 may be inserted therein. By exerting the internal pressure therein the mandrel 32 may be inserted therein smoothly or more smoothly.

As stated above, the hose 10 according to this embodiment includes the reinforcing layer 18 having a high braid or winding density of the reinforcing filament member or reinforcing yarn equal to or larger than 50%, and has a bursting pressure equal to or larger than 5 MPa. However, no great difficulty accompanies in diametrically enlarging the axial end portion of the unvulcanized hose body 12-1 which is first formed in a straight-walled cylindrical shape. That is, the axial end portion of the unvulcanized hose body 12-1 may be easily diametrically deformed.

On the other hand, in this embodiment, as a braid angle of the reinforcing yarn is higher than 48° in the reinforcing layer 18, it is prevented that a radial expanding amount of the main portion 12A is increased when high pressure is exerted inside the hose 10 by fluid and thereby durability of the hose 10 to repeated pressures is lowered. Namely, the radial expansion of the main portion 12A by action of high pressure fluid may be effectively reduced, and durable life of the hose 10 under repeated pressures may be enhanced.

And, in this embodiment, as the inner surface rubber layer 16 has the wall thickness equal to or larger than 1.0 mm at the swaged portion 16B on the axial end portion after the axial end portion is diametrically enlarged, the swaged portion 16B is not broken when the joint fitting 14 is securely swaged to the swaged portion 16B. So, the joint fitting 14 may be favorably attached to the swaged portion 16B.

And, according to the method for producing the hose 10 in this embodiment, the outer surface of the main portion 12A is retained and restrained by the retaining member 34 when the mandrel 32 is force fitted to and inside the axial end portion to diametrically enlarge the axial end portion thereof. Thereby the axial end portion may be favorably diametrically enlarged without causing buckling of the axial end portion.

At that time, when the mandrel 32 is force fitted in the unvulcanized hose body 12-1 while exerting an internal pressure therein, the axial end portion thereof may be more easily diametrically enlarged by force fitting the mandrel 32.

### EXAMPLE

Some example and comparison example hoses or hose bodies are formed or produced having different constructions as shown in Table 1, and each of the hoses or hose bodies is measured and evaluated with respect to insertability of a mandrel, property of a swaged portion, bursting pressure at room temperature (RT), and durability to repeated pressures and high temperature.

In the line “No. of yarns” of the reinforcing layer of each of example and comparison example hoses or hose bodies in Table 1, “3 parallel yarns×48 carriers”, 2 parallel yarns×48 carriers” mean that 3 or 2 parallel reinforcing yarns of 1000 denier (de) are braided on an 48 carrier machine, and “22 yarns×2 spiraled” means that a strand of 22 reinforcing yarns of 1200 de or 3000 de is wound spirally in one direction to form one ply and another strand of 22 yarns is wound spirally in the reversed direction to laminate another ply over the one ply.

In Table 1, property of a swaged portion, bursting pressure at RT, and durability to repeated pressures at high temperature are measured under the following conditions.

[Property of a Swaged Portion (Rubber Breakage When a Hose or Hose Body Bursts at High Temperature]

Each of the example and comparison example hoses or hose bodies is attached to a bath containing oil of 100° C. and is let stand for 30 minutes. Then a pressure is exerted to the hose or hose body while being kept for 30 seconds at every pressure raised by 0.98 MPa until the hose or hose body bursts. It is checked whether there occurs a rubber breakage in a swaged portion when the hose bursts.

[Bursting Pressure at RT]

Bursting pressure at RT indicates water pressure value which causes a hose or hose body to burst when water pressure is exerted at room temperature internally to the hose or hose body at pressure rising speed of 160 Mpa/minute.

[Durability to Repeated Pressures at High Temperature]

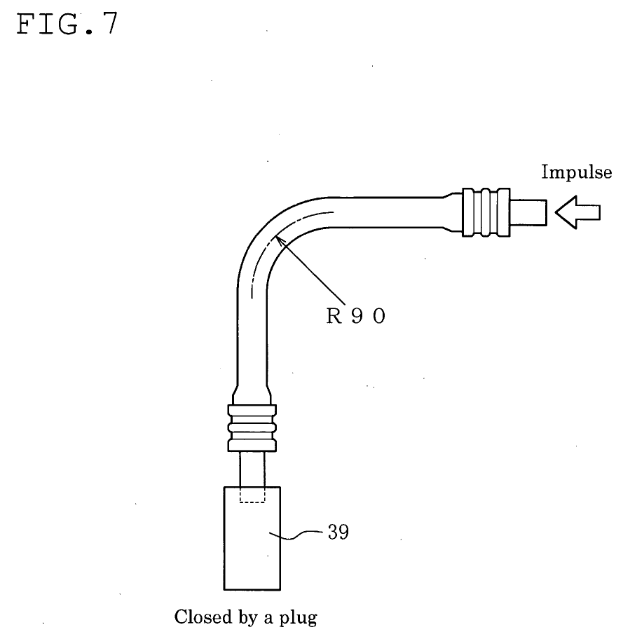

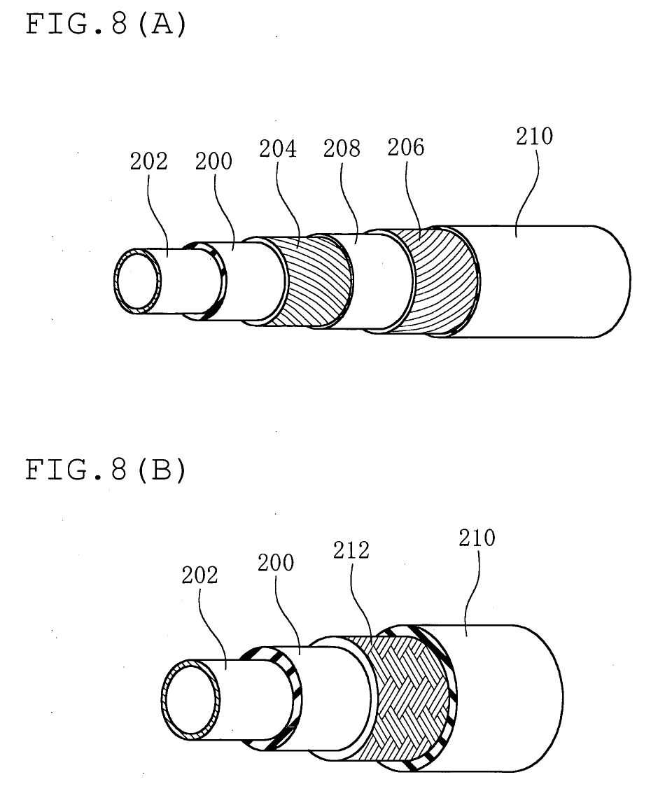

As shown in FIG. 7, a hose is kept bent at about 90° (R90) on an axial center thereof, generally into L-shape, and closed with a plug 39 on one end thereof. And, while the hose is securely fixed at both ends thereof, oil pressure is repeatedly exerted inside the hose and durability of the hose is evaluated.

Here, an evaluation test (impulse test or oil pressure impulse test) is conducted under the condition of repeated pressure 3.5 MPa and pressurizing speed 35 cpm.

The test results are shown in Table 1.

In the lines of “insertability of mandrel when diametrically enlarged”, a meaning of each mark is as follows. A mark “χ” indicates that the mandrel cannot be inserted in a hose body or unvulcanized hose body, and the hose body is crashed (buckled) in an axial direction. A mark “Δ” indicates that the mandrel can be inserted, but tightly, and for example, the hose body or an inner surface of the hose body is scratched by a jig or the mandrel. A mark “◯” indicates that the mandrel is favorably inserted in the hose body. Some columns in the line of “pressurizing at 1 MPa” with regard to insertability of a mandrel, are marked with “Δ”. From this, it may be understood that when pressurized above a certain pressure, a resistance to insertion of a mandrel is increased after all under the pressure exerted by pressurizing fluid.

TABLE 1

| | | | Examples | |
|---|---|---|---|---|
| | | | 1 | 2 |
| Main | Dimension | Inner | 9.0 | 14.5 |
| portion | | diameter | | |
| of hose | | Outer | 16.0 | 22.0 |
| body | | diameter | | |
| | Inner surface | Material | C1-IIR | C1-IIR |
| | layer | Wall | | |
| | | thickness | 2.0 | 1.6 |
| | Reinforcing | Material | PET | PET |
| | layer | No. of | 1000 de | 3000 de |
| | | denier | | |
| | | No. of | 3 parallel yams × | 22 yams × 2 |
| | | yarns | 48 carriers | spiraled |
| | | Braid or | 50 | 53 |
| | | winding | | |
| | | angle (°) | | |
| | | Braid or | 88 | 66 |
| | | winding | | |
| | | density (%) | | |
| | Outer surface | Material | EPM | EPM |
| | layer | Wall | | |
| | | thickness | 1.0 | 1.0 |
| Swaged | Dimension | Inner | 12.0 | 15.8 |
| portion | | diameter | | |
| of hose | | Outer | (17.9) | (22.9) |
| body | | diameter | | |
| | Inner surface | Wall | (1.6) | (1.5) |
| | layer | thickness | | |
| | Outer surface | Wall | (0.9) | (0.95) |
| | layer | thickness | | |

| Diametrically enlarging rate (%) | | 33 | 9 |
|---|---|---|---|
| Insertability of | Not pressurized | x | ∘ |
| mandrel when | Pressurized at | Δ | — |
| diametrically | 0.2 MPa | | |
| enlarged | Pressurized at | ∘ | — |
| | 0.5 MPa | | |
| | Pressurized at | Δ | — |
| | 1.0 MPa | | |

| | | |
|---|---|---|
| Property of swaged portion | ∘ | ∘ |
| (rubber breakage when hose bursts at | | |
| high temperature) | | |
| Bursting pressure at RT (MPa) | 22.4 | 13.9 |
| Durability to repeated pressures at | 100,000 | 100,000 |
| high temperature (cycle) | No disruption | No disruption |

| | | | Comparison Examples | | |
|---|---|---|---|---|---|
| | | | A | B | C |
| Main | Dimension | Inner | 9.0 | 9.0 | 16.0 |
| portion | | diameter | | | |
| of hose | | Outer | 16.0 | 14.4 | 24.0 |
| body | | diameter | | | |
| | Inner surface | Material | C1-IIR | C1-IIR | EPDM |
| | layer | Wall | 2.0 | 1.2 | 2.0 |
| | | thickness | | | |
| | Reinforcing | Material | PET | PET | PA66 |
| | layer | No. of | 1000 de | 1000 de | 1200 de |
| | | denier | | | |
| | | No. of | 3 parallel yarns × | 2 parallel yarns × | 22 yams × 2 |
| | | yarns | 48 carriers | 48 carriers | spiraled |
| | | Braid or | 45 | 50 | 55.5 |
| | | winding | | | |
| | | angle (°) | | | |
| | | Braid or | 80 | 64 | 18 |
| | | winding | | | |
| | | density | | | |
| | | (%) | | | |
| | Outer surface | Material | EPM | EPM | EPDM |
| | layer | Wall | 1.0 | 1.0 | 1.0 |
| Swaged | Dimension | Inner | 12.0 | 12.0 | 18.0 |
| portion | | diameter | | | |
| of hose | | Outer | (17.9) | (16.4) | (25.4) |
| body | | diameter | | | |
| | Inner surface | Wall | (1.6) | (0.95) | (1.8) |
| | layer | thickness | | | |
| | Outer surface | Wall | (0.9) | (0.85) | (0.95) |
| | layer | thickness | | | |

| Diametrically enlarging rate (%) | | 33 | 33 | 13 |
|---|---|---|---|---|
| Insertability of | Not pressurized | Δ | x | ∘ |
| mandrel when | Pressurized at | ∘ | Δ | — |
| diametrically | 0.2 MPa | | | |
| enlarged | Pressurized at | ∘ | ∘ | — |
| | 0.5 MPa | | | |
| | Pressurized at | Δ | Δ | — |
| | 1.0 MPa | | | |

| | | | |
|---|---|---|---|
| Property of swaged portion | ∘ | x | — |
| (rubber breakage when hose bursts at | | | |
| high temperature) | | | |
| Bursting pressure at RT (MPa) | 17.1 | 18.3 | 2.4 |
| Durability to repeated pressures at | 30,000 | 2,000 | — |
| high temperature (cycle) | Pinhole at main | Pinhole at | |
| | portion | swaged portion | |

Note:
*1) Inner diameter, outer diameter and wall-thickness are indicated in mm in Table 1.
*2) Density: Yarn area ratio to an outer surface area of inner surface rubber layer. Density = (yarn width × No. of yarns/(2 × π × outer diameter of an inner surface rubber layer × cos braid or winding angle) ) × 100
*3) In the line “property of swaged portion, a mark “0” means that no rubber breakage occurs, and a mark “X” means that a rubber breakage occurs.
*4) Values in parentheses indicate calculated values.

As seen from the results shown in Table 1, the comparison example A including a reinforcing layer where a braid angle of a reinforcing yarn is as low as 45° is entirely favorable in the insertability of a mandrel. However, in the comparison example A, as the reinforcing layer provides a small pressure resistant effect, the test result of the durability to repeated pressures at high temperature is as low as 30,000 cycles.

In the comparison example B including a inner surface rubber layer where a wall thickness of a swage portion is smaller than 1.0 mm, the test result of the durability to repeated pressures at high temperature is as low as 2,000 cycles and a pinhole is created at the swaged portion. That means the comparison example B is low in the durability to repeated pressures.

On the contrary, the example hoses 1 and 2 exhibit favorable performances relative to any of insertability of a mandrel, property of a swaged portion, bursting pressure and durability to repeated pressures at high temperature.

Although the preferred embodiments have been described above, this is only one of embodiments of the present invention.

For example, depending on circumstances, configuration of the hose 10 may be varied for many purposes in the present invention. The present invention may be constructed and embodied in various configurations and modes within the scope of the present invention.

We claim:

1. A high pressure resistant vibration absorbing hose, comprising:
a hose body having an inner surface layer, a reinforcing layer formed on an outer side of the inner surface layer by braiding or spirally winding reinforcing wire member and an outer surface layer as cover layer on an outer side of the reinforcing layer, the reinforcing layer having a high braid or winding density of the reinforcing wire member of 50% or more, the hose body having a swaged portion on an axial end portion thereof and a main portion other than the swaged portion,
a joint fitting attached to the swaged portion of the hose body, the joint fitting having a rigid insert pipe and a sleeve-like socket fitting, the joint fitting being securely fixed to the swaged portion by securely swaging the socket fitting to the swaged portion in a diametrically contracting direction while the insert pipe is inserted within the swaged portion and the socket fitting is fitted on an outer surface of the swaged portion,
a bursting pressure of the high pressure resistant vibration absorbing hose being 5 MPa or more,
the swaged portion of the hose body being designed to have a larger diameter than the main portion of the hose body in a state before the joint fitting is securely swaged thereto, the inner surface layer having a wall thickness equal to or larger than 1.0 mm at the swaged portion in a state before the joint fitting is securely swaged thereto, and
the reinforcing layer having a braid or winding angle θ of the reinforcing wire member equal to or lower than a neutral angle 54.7° and higher than 48°.

2. The high pressure resistant vibration absorbing hose as set forth in claim 1, wherein the inner surface layer has a wall thickness equal to or larger than 1.5 mm at the swaged portion in the state before the joint fitting is securely swaged thereto, and the reinforcing layer having a braid or winding angle θ of the reinforcing wire member in a range from 50° to 53°.

3. A method for producing the high pressure resistant vibration absorbing hose in particular as defined in claim 1, comprising;
(a) a step of forming an unvulcanized hose body of a straight-walled cylindrical shape laminated with an inner surface rubber layer as the inner surface layer, the reinforcing layer and an outer surface rubber layer as the outer surface layer,
(b) a step of diametrically enlarging an axial end portion of the unvulcanized hose body by force fitting a mandrel inside the axial end portion thereof, after the step of (a),
(c) a step of vulcanizing the unvulcanized hose body while maintaining the axial end portion thereof in diametrically enlarged state, and
an outer surface of the main portion of the unvulcanized hose body being retained and restrained by a retaining member when the mandrel is force fitted inside the axial end portion thereof, and
the mandrel being force fitted in the axial end portion of the unvulcanized hose body in which the outer surface of the main portion is retained and restrained by the retaining member, so as to diametrically enlarge the axial end portion.

4. The method for producing the high pressure resistant vibration absorbing hose as set forth in claim 3, wherein the retaining member has a cylindrical inner surface.

5. The method for producing the high pressure resistant vibration absorbing hose as set forth in claim 3, wherein the mandrel is force fitted inside the axial end portion of the unvulcanized hose body while an internal pressure being exerted in the unvulcanized hose body.

6. The method for producing the high pressure resistant vibration absorbing hose as set forth in claim 5, wherein the internal pressure is exerted in the unvulcanized hose body by way of a pressurizing fluid path running axially through the mandrel.

7. The method for producing the high pressure resistant vibration absorbing hose as set forth in claim 3, wherein the reinforcing layer is designed to have a braid or winding angle θ of the reinforcing wire member equal to or lower than a neutral angle 54.7° and higher than 48° in the step of forming the unvulcanized hose body, and the inner surface layer is designed to have a wall thickness equal to or larger than 1.0 mm at the swaged portion in the step of vulcanizing the unvulcanized hose body.
